(19) United States
(12) Patent Application Publication
(10) Pub. No.: US 2015/0278756 A1
(43) Pub. Date: Oct. 1, 2015

(54) SYSTEMS AND METHODS TO REDUCE SHIPPING COSTS

(71) Applicant: Robert Morcos, Miami, FL (US)

(72) Inventor: Robert Morcos, Miami, FL (US)

(21) Appl. No.: 14/224,929

(22) Filed: Mar. 25, 2014

(51) Int. Cl. G06Q 10/08; B65B 5/04; B65B 5/02; B65B 61/26

(52) U.S. Cl. CPC G06Q 10/0837; B65B 61/26; B65B 5/04; B65B 5/02

(57) ABSTRACT

In accordance with one embodiment, a method to reduce shipping costs for portable electronics is provided. The method involves receiving data related to return shipping address for a group of portable electronics packages. Additionally, the method may include obtaining a first set of standardized unique equipment identity number. For example, the first set of standardized unique equipment identity number is Electronic serial number (“ESN”), an International Mobile Station Equipment Identity (“IMEI”), a media access control address (“MAC”), or the like, or any combination thereof.

### BACKGROUND OF THE INVENTION

1. Field of the Invention

Embodiments of the present invention generally relate to order fulfillment systems and, more particularly, to shipment of prepackaged portable electronic devices.

2. Description of the Related Art

The increasing scope of electronic commerce, fueled by the ubiquity of personal computers, the Internet, and the World Wide Web, has resulted in striking changes to the ways customers may shop for and purchase products. Virtual storefronts, in which customers may view product information including features, specifications, appearance, pricing and availability, have become commonplace even among wholesalers and retailers who have maintained physical customer presences. Much commerce is already being conducted exclusively through virtual storefronts by companies lacking any other customer presence.

Electronic commerce using virtual storefronts offers many advantages, such as lower cost overhead (e.g., due to lack of sales personnel, lack of physical storefronts, highly automated ordering processes, etc.), and a potential customer base limited only by the reach of the Internet. However, one substantial disadvantage to the virtual storefront model is that in many instances, customers have to upfront substantial shipping costs to receive their merchandise upon purchase. The availability of contemporary shipping methods from various common carriers may mitigate some complexities of shipment, but often at substantial additional cost that may rival the price paid for the merchandise. One of such cost is in repackaging the portable electronic product when received by the common carriers from the manufacturer. Such delays may dissuade customers from buying items from online merchants, particularly if those items are more readily available locally or may add substantial additional costs for the manufacturers or wholesale dealers.

### SUMMARY

In accordance with one embodiment, a method to reduce shipping costs for portable electronics is provided. The method involves receiving data related to return shipping address for a group of portable electronics packages. Additionally, the method may include obtaining a first set of standardized unique equipment identity number. For example, the first set of standardized unique equipment identity number is Electronic serial number (“ESN”), an International Mobile Station Equipment Identity (“IMEI”), a media access control address (“MAC”), or the like, or any combination thereof.

In accordance with an embodiment, the method may further include obtaining a second set of unique serial number. For example, the second set of unique serial number may be an pre-installed subscriber identification module (“SIM”) card's number, universally unique identifier (“UUID”), Internet Protocol address (“IP address”), or the like, or any combination thereof.

The method involves manufacturing an original packaging box for the portable electronics. For example, the portable electronics may be one of a cell phone, a tablet, a laptop, gaming device, or the like. During the manufacturing of the portable electronics box one side of the box in painted in a monotone color. For example, the monotone color is one of white, or black color, or any background color that may help legibly read the written characters on the box.

One step in the method described herein may include printing the return shipping address at the prescribed location of the box on the monotone color side. For example, in United States the prescribed location of return address is the top left corner of the monotone color side. Alternatively, the prescribed location for return address in different countries may be as required by the postal code of the said country.

Further, the method may involve printing the first set of standardized unique equipment identity number at the prescribed location on the monotone color side. Yet another set may involve printing the second set of unique serial number at the prescribed location on the monotone color side. The first set of number and the second set of number may be printed on the monotone color side such that the two set of numbers are non-overlapping.

The shipping entity—an individual, corporation, or the like—may identify the contents of the box simply by scanning the first and the second set of unique numbers. This eliminates the need for the shipping entity to open the box and repackage the box for the final shipment. The first and the second set of unique numbers are printed at a prescribed location such that in one embodiment the prescribed location being the space for placing a shipping label. For example, the prescribed location of the shipping address is the center of the monotone color side. When a shipper places the shipping label on the box, the shipping label conceals the first and the second unique numbers. Thus, preventing a third party to know the identity of the item within the box.

Hence, the method enables shipping the portable electronics without opening the box, capturing the contents of the box by scanning the first and the second set of unique numbers on the box, and places a shipping label over the first and the second set of unique numbers. In one embodiment of the subject matter described herein, the method of shipping phones may be for the US government's Lifeline program providing a discount on phone service for qualifying low-income consumers.

In accordance with another embodiment, a system to reduce shipping costs for portable electronics is provided. The system comprises a computer storable medium storing a return shipping address for a group of a portable electronics packages.

The system may have an electronic circuitry for identifying a first set of standardized unique equipment identity number. The system further may include an electronic circuitry identifying a second set of unique serial number. In one embodiment the system further comprises an apparatus for manufacturing a portable electronic box, having at least one side of the box in monotone color.

The apparatus printing the return shipping address at the prescribed location of the box on the monotone color side. The apparatus printing the first set of standardized unique equipment identity number at the prescribed location on the monotone color side. The apparatus printing the second set of unique serial number at the prescribed location on the monotone color side, the first set of number and the second set of number non-overlapping.

The first set of standardized unique equipment identity number is an “Electronic serial number” (“ESN”), an International Mobile Station Equipment Identity (“IMEI”), a media access control address (“MAC”), or the like, or any combination thereof. The second set of unique serial number is an, pre-installed subscriber identification module (“SIM”) card's number, universally unique identifier (“UUID”), Internet Protocol address (“IP address”), or the like, or any combination thereof. For example, the portable electronics is one of a cell phone, a tablet, a laptop, gaming device, or the like. The first and the second set of unique numbers are printed at a prescribed location, the prescribed location being within the space provided for placing a shipping label, the shipping label concealing the first and the second unique numbers.

The prescribed location of return address is the top left corner of the monotone color side. The prescribed location of the shipping address is the center of the monotone color side. The portable electronic device is capable of telephonic calls, the portable electronic device having a subscriber identification module (“SIM”) cards installed during production.

### BRIEF DESCRIPTION OF THE DRAWINGS

The drawings, in which like numerals represent similar parts, illustrate generally, by way of example, but not by way of limitation, various embodiments discussed in the present document.

FIG. 1 illustrates a flow chart to reduce shipping costs for portable electronics in accordance with an embodiment.

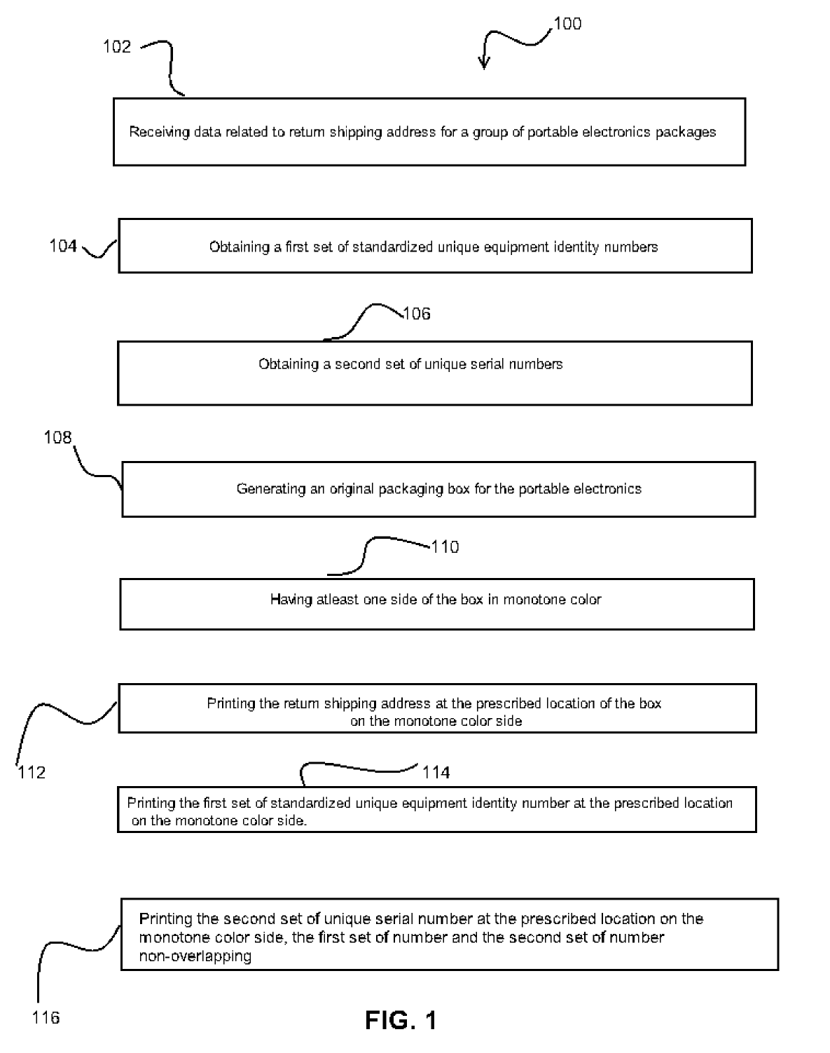

FIG. 2 illustrates a system to reduce shipping costs for portable electronics in accordance with an embodiment.

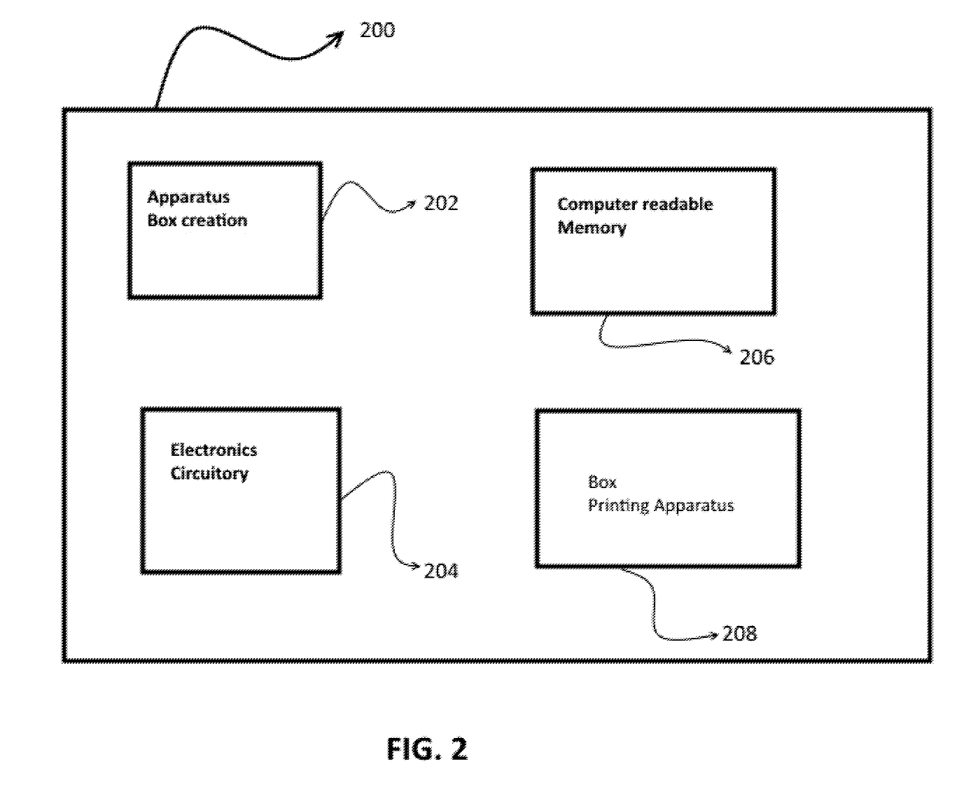

### DETAILED DESCRIPTION

The foregoing summary, as well as the following detailed description of certain embodiments of the subject matter set forth herein, will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the terms “a” or “an” are used, as is common in patent documents, to include one or more than one. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

The methods and systems of the present invention recognize that distribution networks are one of the main areas affecting the value chain. The present invention recognizes that an optimum network provides customers with the right goods in the right quantity, at the right place, at the right time, with minimum total distribution costs. Further, aside from freight expenses, critical criteria for the design of efficient distribution networks are: order cycle time, customer service and transit network visibility—with the greater pressure on reliability and speed of deliveries requiring comprehensive information networks that feature order visibility and in-transit intervention.

When the company plans a group shipment in the system, the method 100 for reducing shipping cost would determine the best shipment method for shipping all the packages. The subject matter disclosed herein proposes to package the portable electronics during the production. The portable electronics may be manufacture and during the packaging the portable electronics, instead of putting them in retail ready boxes the method 100 places them in a box that may be completely white. The white box prevents one from guessing if there is a portable electronics inside the white box. The inside of the box has an additional shield to protect the handset if it is dropped.

Next, the process may involve printing on the box the return shipping address. Additionally, in one embodiment the process may involve printing on the box a small label with both an IMEI (serial number) and the SIM card number. The phone may receive SIM cards and insert them during production of the phones so that during the packaging the SIM cards are present in the phones. The operator shall be able to extract the information of the item packaged within the box, without having to open the packaging. The operator/shipper will be able to scan the two numbers on the box, place a shipping label over it and place it in the mail. Additionally, the operator/shipper will save money by saving on the packaging cost and time. The process may be ideal for the Lifeline government program.

Accordingly, an embodiment of the present invention comprises a method and system for companies to reorganize their inbound and outbound distribution networks by manufacturers so that transitions between participants flow more smoothly. In a further embodiment of the present invention, said method and system comprises a comprehensive information network featuring order visibility and in-transit intervention, thereby increasing reliability and speed of deliveries. A further embodiment of the present invention comprises a method and system for providing users with a system and method to ensure consistent on-time deliveries at the best price with complete visibility.

In accordance with one embodiment, a method 100 to reduce shipping costs for portable electronics is provided. At 102 the method 100 involves receiving data related to return shipping address for a group of portable electronics packages. Additionally, the method 100 may include obtaining a first set of standardized unique equipment identity number at 104. For example, the first set of standardized unique equipment identity number is Electronic serial number (“ESN”), an International Mobile Station Equipment Identity (“IMEI”), a media access control address (“MAC”), or the like, or any combination thereof.

In accordance with an embodiment, the method 100 may further include obtaining a second set of unique serial number at 106. For example, the second set of unique serial number may be an pre-installed subscriber identification module (“SIM”) card's number, universally unique identifier (“UUID”), Internet Protocol address (“IP address”), or the like, or any combination thereof.

At 108 the method 100 involves manufacturing an original packaging box for the portable electronics. For example, the portable electronics may be one of a cell phone, a tablet, a laptop, gaming device, or the like. At 110 During the manufacturing of the portable electronics box one side of the box in painted in a monotone color. For example, the monotone color is one of white, black, or any background color that may help legibly read the written characters on the box.

One step in the method described herein may include printing the return shipping address at the prescribed location of the box on the monotone color side at 112. For example, in United States the prescribed location of return address is the top left corner of the monotone color side. Alternatively, the prescribed location for return address in different countries may be as required by the postal code of the said country.

Further, at 114 the method may involve printing the first set of standardized unique equipment identity number at the prescribed location on the monotone color side. Yet another set may involve printing the second set of unique serial number at the prescribed location on the monotone color side at 116. The first set of number and the second set of number may be printed on the monotone color side such that the two set of numbers are non-overlapping. The method further comprises adding a warning sign above a seal. The seal is meant to indicate unopened box. The warning sign above the seal states “do not accept if seal is broken”. The warning sign is meant to warn the user that they are not required to accept the box and contents inside if the seal is broken. If the seal is broken it may be shipped back to the shipping entity.

Manufacturers, retailers, wholesalers, distribution centers, and other distributors of product or goods (which may collectively be referred to as distributors) typically maintain an inventory of various items that may be ordered by and shipped to clients or customers. This inventory may be maintained and processed at materials handling facility or facilities such as distribution centers, cross-docking facilities, and order fulfillment facilities. The shipping entity—an individual, corporation, or the like—may identify the contents of the box simply by scanning the first and the second set of unique numbers. This eliminates the need for the shipping entity to open the box and repackage the box for the final shipment. The first and the second set of unique numbers are printed at a prescribed location such that in one embodiment the prescribed location being the space for placing a shipping label. For example, the prescribed location of the shipping address is the center of the monotone color side. When a shipper places the shipping label on the box, the shipping label conceals the first and the second unique numbers. Thus, preventing a third party to know the identity of the item within the box.

Hence, the method enables shipping the portable electronics without opening the box, capturing the contents of the box by scanning the first and the second set of unique numbers on the box, and places a shipping label over the first and the second set of unique numbers. In one embodiment of the subject matter described herein, the method of shipping phones may be for the US government's Lifeline program providing a discount on phone service for qualifying low-income consumers.

In accordance with another embodiment, a system 200 to reduce shipping costs for portable electronics is provided. The system 200 comprises a computer storable medium 206 storing a return shipping address for a group of a portable electronics packages. It is to be understood that the embodiments and features that are described herein may be implemented by hardware, software, firmware or any combination thereof. Various embodiments described herein are described in the general context of methods or processes, which may be implemented in one embodiment by a computer program product, embodied in a computer-readable medium, including computer-executable instructions, such as program code, executed by computers in networked environments.

The various embodiments and/or components, for example, the modules, elements, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

The system 200 may have an electronic circuitry 204 for identifying a first set of standardized unique equipment identity number. The system 200 further may include an electronic circuitry 204 identifying a second set of unique serial number. In one embodiment the system 200 further comprises an apparatus 202 for manufacturing a portable electronic box, having at least one side of the box in monotone color.

The printing apparatus 208 the return shipping address at the prescribed location of the box on the monotone color side. The printing apparatus 208 prints the first set of standardized unique equipment identity number at the prescribed location on the monotone color side. The apparatus 208 printing the second set of unique serial number at the prescribed location on the monotone color side, the first set of number and the second set of number non-overlapping.

The first set of standardized unique equipment identity number is an “Electronic serial number” (“ESN”), an International Mobile Station Equipment Identity (“IMEI”), a media access control address (“MAC”), or the like, or any combination thereof. The second set of unique serial number is an, pre-installed subscriber identification module (“SIM”) card's number, universally unique identifier (“UUID”), Internet Protocol address (“IP address”), or the like, or any combination thereof. For example, the portable electronics is one of a cell phone, a tablet, a laptop, gaming device, or the like. The first and the second set of unique numbers are printed at a prescribed location, the prescribed location being within the space provided for placing a shipping label, the shipping label concealing the first and the second unique numbers.

The prescribed location of return address is the top left corner of the monotone color side. The prescribed location of the shipping address is the center of the monotone color side. The portable electronic device is capable of telephonic calls, the portable electronic device having a subscriber identification module (“SIM”) cards installed during production.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method to reduce shipping costs for portable electronics is provided, said method comprising the steps of:
receiving data related to return shipping address for a group of portable electronics packages;
obtaining a first set of standardized unique equipment identity number;
obtaining a second set of unique serial number;
generating an original packaging box for the portable electronics;
having at least one side of the box in monotone color;
printing the return shipping address at the prescribed location of the box on the monotone color side;
printing the first set of standardized unique equipment identity number at the prescribed location on the monotone color side; and
printing the second set of unique serial number at the prescribed location on the monotone color side, the first set of number and the second set of number non-overlapping.

2. The method of claim 1, wherein the first set of standardized unique equipment identity number is Electronic serial number (“ESN”), an International Mobile Station Equipment Identity (“IMEI”), a media access control address (“MAC”), or the like, or any combination thereof.

3. The method of claim 1, wherein the second set of unique serial number is an, pre-installed subscriber identification module (“SIM”) card's number, universally unique identifier (“UUID”), Internet Protocol address (“IP address”), or the like, or any combination thereof.

4. The method of claim 1, wherein the portable electronics is one of a cell phone, a tablet, a laptop, gaming device, or the like.

5. The method of claim 1, wherein the monotone color is one of white, or black color.

6. The method of claim 1, wherein the prescribed location of return address is the top left corner of the monotone color side.

7. The method of claim 1, wherein the prescribed location of the shipping address is the center of the monotone color side.

8. The method of claim 1, wherein the portable electronic device is capable of telephonic calls, the portable electronic device having a subscriber identification module (“SIM”) cards installed during production.

9. The method of claim 1 further comprises enabling the shipping entity to identify the contents of the box by scan the first and the second set of unique numbers.

10. The method of claim 1, wherein the first and the second set of unique numbers are printed at a prescribed location, the prescribed location being within the space provided for placing a shipping label, the shipping label concealing the first and the second unique numbers.

11. The method of claim 1 further comprises shipping the portable electronics without opening the box, capturing the contents of the box by scanning the first and the second set of unique numbers on the box, place a shipping label over the first and the second set of unique numbers.

12. The method of claim 1 further comprises a method of shipping phones under Lifeline program provided a discount on phone service for qualifying low-income consumers.

13. A system to reduce shipping costs for portable electronics is provided, the system comprising:
a computer storable medium storing a return shipping address for a group of portable electronics packages;
an electronic circuitry for identifying a first set of standardized unique equipment identity number;
an electronic circuitry identifying a second set of unique serial number; and
a apparatus for manufacturing a portable electronic box, having at least one side of the box in monotone color,
the apparatus printing the return shipping address at the prescribed location of the box on the monotone color side,
the apparatus printing the first set of standardized unique equipment identity number at the prescribed location on the monotone color side,
the apparatus printing the second set of unique serial number at the prescribed location on the monotone color side, the first set of number and the second set of number non-overlapping.

14. The system of claim 13, wherein the first set of standardized unique equipment identity number is an “Electronic serial number” (“ESN”), an International Mobile Station Equipment Identity (“IMEI”), a media access control address (“MAC”), or the like, or any combination thereof.

15. The system of claim 13, wherein the second set of unique serial number is an, pre-installed subscriber identification module (“SIM”) card's number, universally unique identifier (“UUID”), Internet Protocol address (“IP address”), or the like, or any combination thereof.

16. The system of claim 13, wherein the portable electronics is one of a cell phone, a tablet, a laptop, gaming device, or the like.

17. The system of claim 13, wherein the first and the second set of unique numbers are printed at a prescribed location, the prescribed location being within the space provided for placing a shipping label, the shipping label concealing the first and the second unique numbers.

18. The system of claim 13, wherein the prescribed location of return address is the top left corner of the monotone color side.

19. The system of claim 13, wherein the prescribed location of the shipping address is the center of the monotone color side.

20. The system of claim 13, wherein the portable electronic device is capable of telephonic calls, the portable electronic device having a subscriber identification module (“SIM”) cards installed during production.
